(19) United States
(12) Patent Application Publication
(10) Pub. No.: US 2022/0197196 A1
(43) Pub. Date: Jun. 23, 2022

(54) CONNECTION STRUCTURE OF TWO FUSING DEVICES

(71) Applicant: Hewlett-Packard Development Company, L.P., Spring, TX (US)

(72) Inventors: Seungsup LEE, Seongnam-si (KR); Byungjun LEE, Seongnam-si (KR)

(21) Appl. No.: 17/611,654

(22) PCT Filed: Sep. 30, 2020
(86) PCT No.: PCT/US2020/053397

§ 371 Date: Nov. 16, 2021

(30) Foreign Application Priority Data
Oct. 23, 2019 (KR) 10-2019-0132425

(51) Int. Cl. G03G 15/20

(52) U.S. Cl. CPC G03G 15/2021; G03G 2215/2006; G03G 2215/2083

(57) ABSTRACT

An example image forming apparatus includes, a main body, a first fixing device disposed in the main body to primarily fix a toner image transferred on a printing medium while passing through a transfer device, a first discharge device to discharge the printing medium having passed through the first fixing device from the main body, and a second fixing device disposed in the main body to additionally fix the toner image on the printing medium having passed through the first fixing device, wherein the second fixing device may be supplied with the printing medium through a connection path returning from the first discharge device into the main body and connected to the second fixing device.

### BACKGROUND

An image forming apparatus refers to an apparatus for printing an image on a printing medium, and may include a printer, a copying machine, a scanner, a fax machine, and a multifunction printer incorporating these functions.

An image forming apparatus employing an electrophotographic method scans light on a photosensitive member charged to a predetermined potential to form an electrostatic latent image on a surface of the photosensitive member and supplies toner to the electrostatic latent image to form a visible image. The visible image formed on the photosensitive member is transferred to the printing medium directly or via an intermediate transfer member.

The visible image transferred to the printing medium is fixed to the printing medium while passing through a fixing device. At this time, various image qualities are obtained depending on the fixing of the transferred image. That is, different fixing conditions, such as fixing for general printing or fixing for photofinishing, may be applied depending on the desired image quality.

Enabling an image forming apparatus to be capable of applying various fixing conditions may result in enhancement of utility of the image forming apparatus.

### BRIEF DESCRIPTION OF THE DRAWINGS

Various examples will be described below by referring to the following figures.

FIG. 1 is a schematic diagram of an image forming apparatus according to an example.

FIG. 2 is a partial enlarged view of FIG. 1 according to an example.

FIG. 3A to FIG. 3F illustrate movement of a printing medium in an image forming apparatus according to an example.

FIG. 4 is a block diagram showing a control configuration of an image forming apparatus according to an example.

FIG. 5 is a flowchart of an image forming method according to an example.

### DETAILED DESCRIPTION OF EXAMPLES

One or more examples will be described below with reference to the accompanying drawings. However, various examples may be implemented in various different forms, and the examples described herein are not intended to be limited to a specific form.

Portions irrelevant to the description are omitted for clear understanding, and like reference numerals designate like elements throughout the specification.

In addition, the size and thickness of each component shown in the drawings are arbitrarily shown for convenience of description and are not necessarily limited to those shown in the drawings.

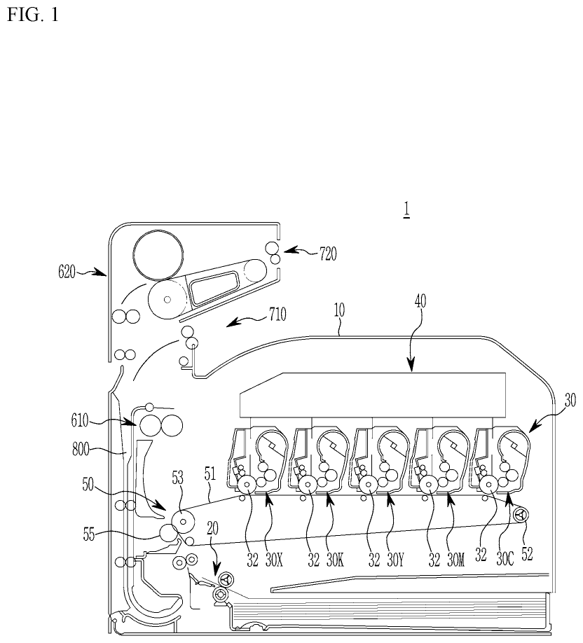

FIG. 1 is a schematic diagram of an image forming apparatus according to an example.

Referring to FIG. 1, an image forming apparatus 1 includes a main body 10, a feeding device 20, a developing device 30, a scanning device 40, a transfer device 50, a first fixing device 610, a second fixing device 620, a first discharge device 710, and a second discharge device 720.

The feeding device 20 stores and supplies a printing medium S. The developing device 30 includes photosensitive media 32 for forming an electrostatic latent image of a target image. The scanning device 40 forms an electrostatic latent image on the photosensitive media 32 of the developing device 30. The transfer device 50 transfers the electrostatic latent image formed on the photosensitive media 32 to the printing medium S supplied from the feeding device 20. The first fixing device 610 fixes a toner image transferred to the printing medium S to the printing medium S. The first discharge device 710 discharges a printing medium S that has passed through the first fixing device 610. The second fixing device 620 additionally fixes the toner image on the printing medium S that has passed through the first fixing device 610. The second discharge device 720 discharges the printing medium S that has passed through the second fixing device 620. The feeding device 20, the developing device 30, the scanning device 40, the transfer device 50, the first fixing device 610, the second fixing device 620, the first discharge device 710, and the second discharge device 720 are disposed in an interior of the main body 10, and interact with one another.

The feeding device 20 may be provided, for example, at a lower portion of the main body 10, and may supply the printing medium S toward the developing device 30.

The developing device 30 may include a plurality of developers 30C, 30M, 30Y, 30K, and 30X for developing an electrostatic latent image to a visible image through a developer (for example, a toner) depending on colors. The developers 30C, 30M, 30Y, and 30K may store, for example, one of developing agents of cyan (C), magenta (M), yellow (Y), and black (K) colors therein to develop the cyan (C), magenta (M), yellow (Y), and black (K) colors, respectively. On the other hand, the developer 30X may store, for example, a clear toner therein to implement a glossy finish.

The scanning device 40 irradiates the photosensitive media 32 provided on the developers 30C, 30M, 30Y, 30K, and 30X, respectively, with light containing image information such that the electrostatic latent image may be formed on the surface photosensitive media 32.

The transfer device 50 includes, for example, a transfer belt 51, a drive roller 52, a driven roller 53, and a transfer roller 55. The driving roller 52 and the driven roller 53 are disposed on both sides of an interior space of the transfer belt 51 to drive the transfer belt 51 to rotate. As the transfer belt 51 rotates, the developing agents of the developers 30C, 30M, 30Y, 30K, and 30X developed on the photosensitive media 32 as visible images are transferred onto the transfer belt 51 in a superimposed manner. The transfer roller 55 is disposed to face the driven roller 53 interposing the transfer belt 51 therebetween. Therefore, as the printing medium S passes between the transfer roller 55 and the transfer belt 51, the visible image transferred to the transfer belt 51 is transferred onto the printing medium S.

In the illustrated example of FIG. 1, the transfer device 50 uses the transfer belt 51 as an intermediate transfer body to transfer an image to the printing medium S. In other examples, an image may be directly transferred from the photosensitive media 32 to the printing medium S. Furthermore, other variations are also possible.

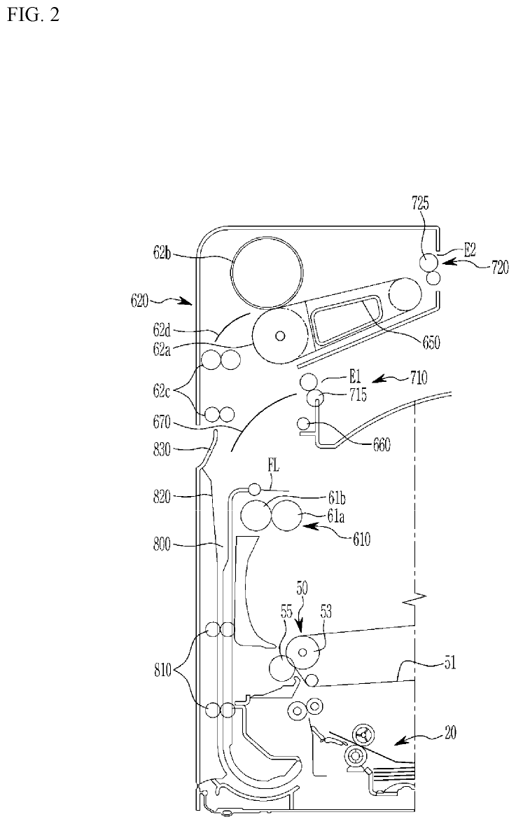

FIG. 2 is a partial enlarged view of FIG. 1 according to an example.

Referring to FIG. 2, the first fixing device 610, the second fixing device 620, the first discharge device 710, and the second discharge device 720 are further described.

The first fixing device 610 is disposed on a downstream side of the transfer device 50, for example, on an upper side of the transfer device 50. The first fixing device 610 is to fix the toner image transferred onto the printing medium S. For this purpose, in the first fixing device 610, a first heating roller 61a is disposed toward a surface of the printing medium S on which the image is transferred, and a first pressure roller 61b is disposed at an opposite side interposing the printing medium S. The first heating roller 61a may be rotated by receiving torque from a first motor M1.

The first fixing device 610 applies a predetermined heat and a predetermined pressure to the printing medium S, while moving the printing medium S at a predetermined speed (e.g., a first moving speed), to fix the toner image formed on the printing medium S. A fixing condition of the first fixing device 610, that is, the first moving speed (e.g., a speed corresponding to 30 ppm) and the predetermined heat and pressure, may be set to meet design conditions based on a target image quality. For example, the fixing condition of the first fixing device 610 may be set to a condition appropriate for normal printing (e.g., printing on a plain paper not requiring photofinishing).

The second fixing device 620 may be disposed on a downstream side of the first fixing device 610, for example above the first fixing device 610, to additionally (i.e., secondarily) fix the toner image of the printing medium S primarily fixed by first fixing device 610. That is, the second fixing device 620 may additionally fix the same surface as the primarily fixed surface of the printing medium S. For this purpose, in the second fixing device 620, a second heating roller 62a is disposed toward the surface of the printing medium S that is primarily fixed, and a second pressure roller 62b is disposed at an opposite side interposing the printing medium S. The second heating roller 62a may be rotated by receiving torque from a second motor M2.

The second fixing device 620 applies a predetermined heat and a predetermined pressure to the printing medium S, while moving the printing medium S at a predetermined speed (e.g., a second moving speed), to fix the toner image formed on the printing medium S. A fixing condition of the second fixing device 620, that is, the second moving speed (e.g., a speed corresponding to 4 ppm) and the predetermined heat and pressure, may be set to meet design conditions based on a target image quality. For example, the fixing condition of the second fixing device 620 may be set to a condition appropriate for photofinishing printing.

The desired print quality of the first fixing device 610 and the second fixing device 620 may vary depending on the design requirements, which may be determined according to the design requirements.

The first discharge device 710 discharges the printing medium S that has passed through the first fixing device 610 through a first outlet E1. To this end, the first discharge device 710 includes a pair of first discharge rollers 715 for discharging the printing medium S.

The second discharge device 720 discharges the printing medium S that has passed through the second fixing device 620 through a second outlet E2. To this end, the second discharge device 720 includes a pair of second discharge rollers 725 for discharging the printing medium S.

The first outlet E1 and the second outlet E2 may be formed in the same direction, for example.

A cooling device 650 may be provided between the second heating roller 62a of the second fixing device 620 and the second outlet E2, to cool a fixing surface of the printing medium S that is heated (i.e., secondarily fixed) by the second heating roller 62a. The cooling device 650 may include, for example, a duct to form an air passage to allow the fixing surface of the printing medium S to contact external air.

A separate space 800 for temporarily holding the printing medium S is disposed on a connection path along which the printing medium S moves from the first fixing device 610 to the second fixing device 620. For example, the separate space 800 may be disposed between the main body 10 and a later side of the first fixing device 610, as shown in FIG. 2. The separate space 800 may be disposed vertically (e.g., by more than half). Since the separate space 800 may be formed between the main body 10 and the later side of the first fixing device 610, the connection path for moving the printing medium S from the first discharge device 710 to the second fixing device 620 may be formed spatially efficiently.

The separate space 800 may include separate space rollers 810 therein. The separate space 800 may be formed by separate space wall members 820 on both left and right sides in the drawing. The separate space 800 may be separated from the first fixing device 610 by the separate space wall member 820.

The separate space 800 may also be utilized as a duplex space for duplex printing, for example, when the image forming apparatus 1 supports duplex printing of the printing medium S. An example in which the image forming apparatus 1 supports duplex printing will be described below in more detail.

The second fixing device 620 may be disposed above the separate space 800. Since the second fixing device 620 is disposed above the separate space 800, a mechanical arrangement of the image forming apparatus 1 including both the first and second fixing devices 610 and 620 may become compact.

In the example image forming apparatus 1, the same fixing surface of the printing medium S is fixed by the first fixing device 610 and the second fixing device 620, which may be understood more clearly from a description of a movement of the printing medium S that will be described below.

Hereinafter, an example process of moving the printing medium S from the first fixing device 610 to the second fixing device 620 will be described.

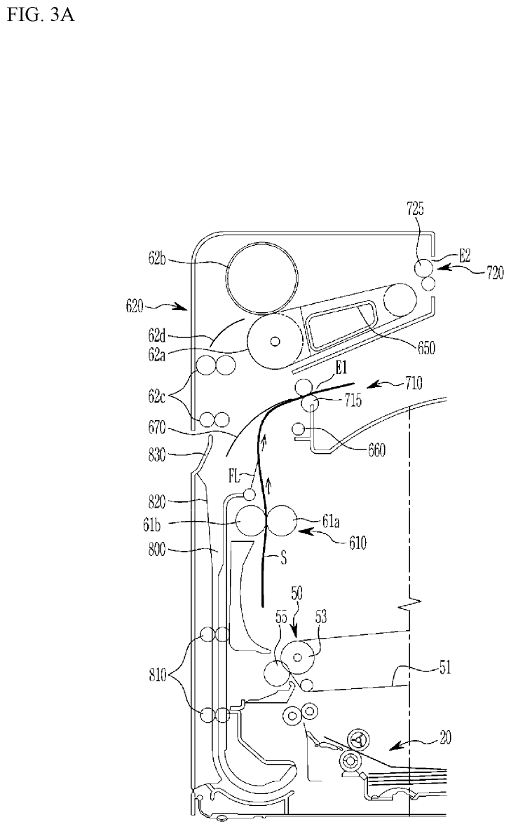

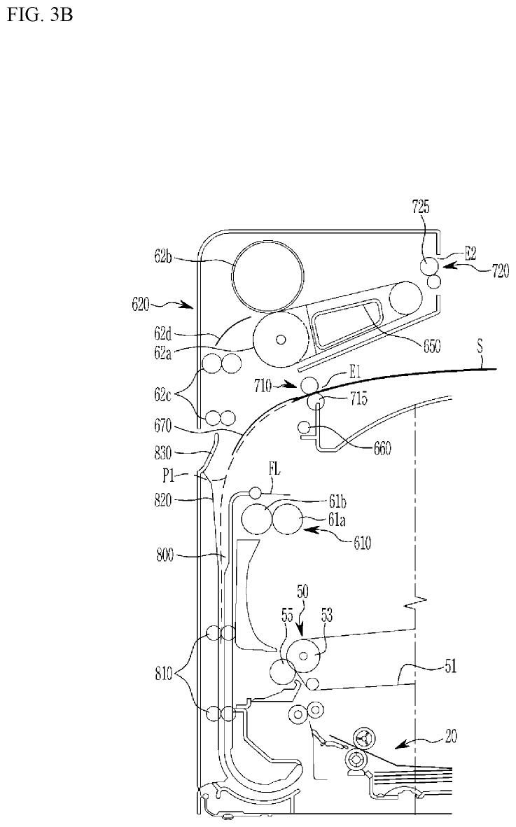

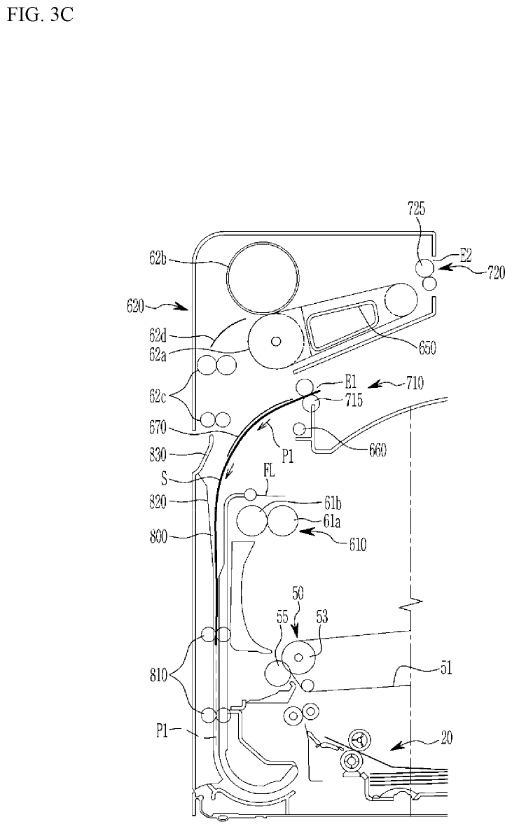

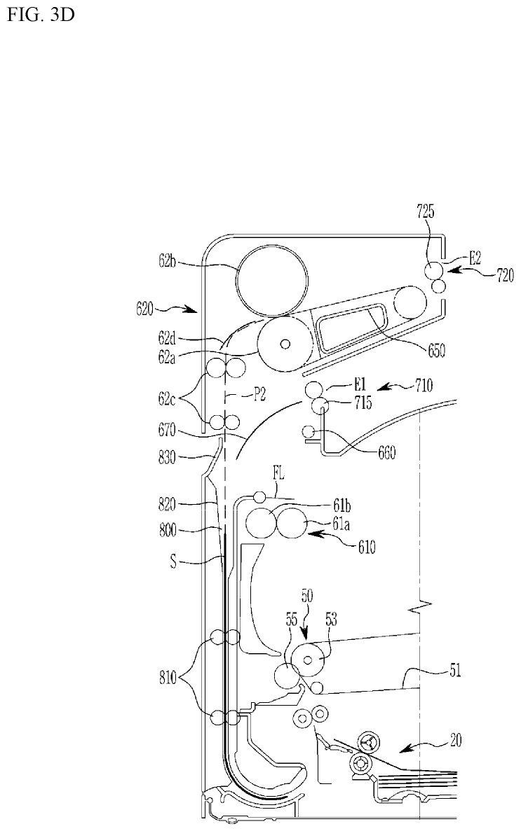

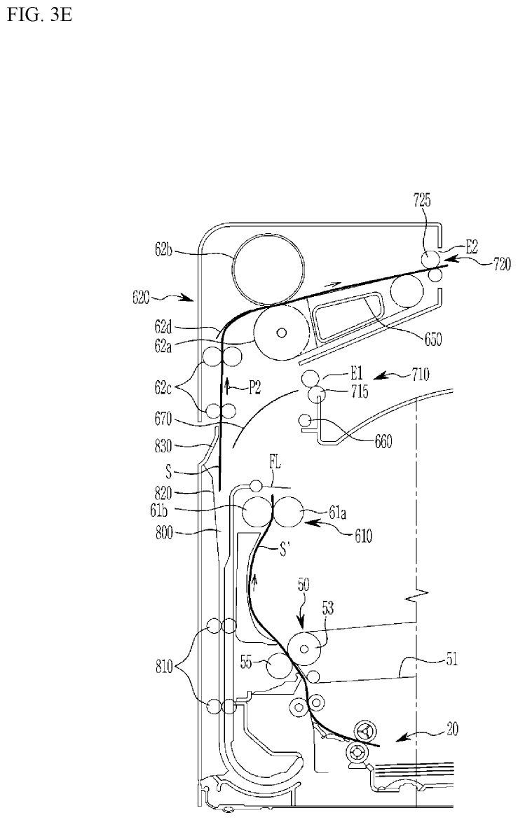

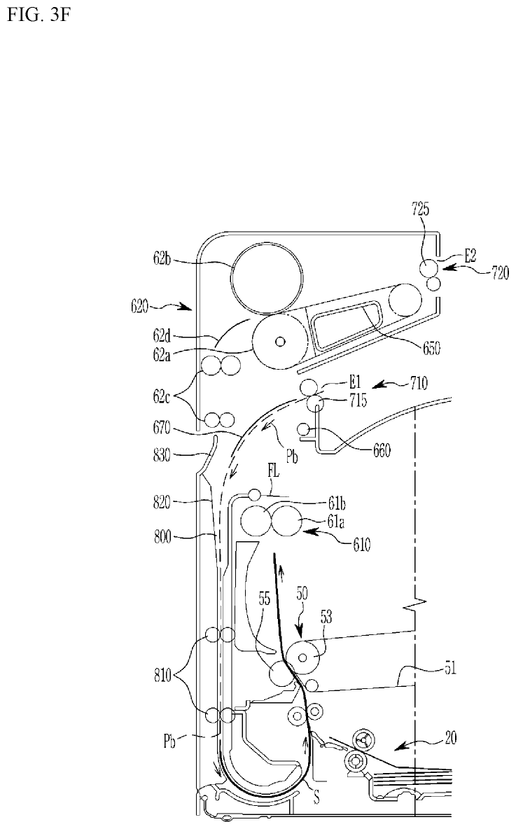

FIGS. 3A to 3F illustrate movement of a printing medium in an image forming apparatus according to an example.

Referring to FIG. 3A, an image transferred to the printing medium S in the transfer device 50 is fixed to a transfer surface while passing through the first fixing device 610. A front end of the printing medium S leaving the first fixing device 610 starts to be discharged through the first outlet E1 through the pair of first discharge rollers 715 of the first discharge device 710.

The pair of first discharge rollers 715 may be driven in a reverse rotation and, when the pair of first discharge rollers 715 are driven in the reverse rotation, the printing medium S may reenter an inside of the main body 10. As mentioned above, the separate space 800 is formed between the first fixing device 610 and the main body 10 to receive the printing medium S that moves back into the main body 10. That is, when the printing medium S is returned to the inside of the main body 10 by the reverse rotation of the pair of first discharge rollers 715, the printing medium S is not returned to the transfer device 50 but enters the separate space 800.

Referring to 3B, before the printing medium S completely exits the first outlet E1, for example, before a rear end of the printing medium S leaves the transfer device 50 and reaches the pair of first discharge rollers 715, the pair of first discharge rollers 715 may be driven in the reverse rotation.

As an example, a gate flap FL may be provided between the transfer device 50 and the pair of first discharge rollers 715, and may alternate between closed and open states depending on whether the printing medium S is passing. That is, while the printing medium S moves from the transfer device 50 to the pair of first discharge rollers 715, the gate flap FL may become closed when the rear end of the printing medium S passes through the gate flap FL. The opening and closing of the gate flap FL may be variously implemented. For example, the flap may be provided with a spring (not shown) that applies elasticity in a closing direction. In this case, the flap FL may be opened by the printing medium S when the front end of the printing medium S starts to leave the transfer device 50, and may be closed when the rear end of the printing medium S leaves the gate flap FL.

Whether the rear end of the printing medium S is completely out of the transfer device 50 may be detected in various ways. For example, a photo sensor 660 that detects whether the rear end of the printing medium S has passed may be provided between the gate flap FL and the pair of first discharge rollers 715. In another example, a switch (not shown) for detecting the closing of the gate flap FL may be provided. In another example, whether the rear end of the printing medium S has passed the gate flap FL may be determined by calculating a moving distance of the printing medium S after entering the transfer device 50 from a rotation angle of the transfer roller 55.

After the rear end of the printing medium S passes through the gate flap FL, the pair of first discharge rollers 715 is driven in a reverse rotation to move the printing medium S toward the separate space 800, before the rear end of the printing medium S reaches the pair of first discharge rollers 715. For example, the pair of first discharge rollers 715 may be driven in the reverse rotation immediately after the rear end of the printing medium S passes through the gate flap FL.

Referring to FIG. 3C, a backward movement guide member 670 may be disposed in a path from the pair of first discharge rollers 715 to the separate space 800, at an opposite side of the gate flap FL, to guide the rear end of the printing medium to stably enter the separate space 800 when the rear end of the printing medium S moves backward.

When the pair of first discharge rollers 715 reversely rotates after the rear end of the printing medium S exits the gate flap FL, the rear end of the printing medium S may be guided by the backward movement guide member 670 to enter the separate space 800. In this case, the printing medium S is bent in accordance with a shape (i.e., profile) of the backward movement guide member 670, and thereby the rear end of the printing medium S enters between separate space rollers 810. By the separate space wall members 820 formed in the longitudinal direction of the separate space 800, the rear end of the printing medium S may stably enter between the separate space rollers 810.

The separate space rollers 810 may be driven in the reverse rotation until the printing medium S is completely accommodated in the separate space 800. Whether the printing medium S is completely accommodated in the separate space 800 may be calculated, for example, based on a reverse rotation distance of the pair of first discharge rollers 715 and a reverse rotation distance of the separate space rollers 810, but is not limited thereto.

As such, the printing medium S is moved back into the main body 10 along a first connection path P1 from the first discharge device 710 to the separate space 800. In this first connection path P1, the printing medium S is moved backward by the reverse rotation of the pair of first discharge rollers 715 and the separate space rollers 810.

Referring to FIG. 3D, after the printing medium S is accommodated in the separate space 800, the separate space rollers 810 rotate in the forward direction to move the printing medium S forward (e.g., moving upward in the drawing).

A second connection path P2 is formed between the separate space 800 and the second fixing device 620, along the wall surface of the main body 10. For example, the second connection path P2 may be linearly formed in a vertical direction, and a delivery guide member 830 may be disposed in the second connection path P2, to stably supply the printing medium S to the second fixing device 620 (e.g., to feeder rollers 62c). In another example, the second connection path P2 may be formed in a bent profile, and a delivery guide member (not shown) may be disposed in the second connection path P2, to stably supply the printing medium S to the second fixing device 620.

Along the first connection path P1, the printing medium S moves backward by the reverse rotation of the pair of first discharge rollers 715 and the separate space rollers 810. In comparison, along the second connection path P2, the printing medium S moves forward by the forward rotation of the separate space rollers 810 and the feeder rollers 62c.

For example, when the separate space rollers 810 are rotated forward, the printing medium S is supplied to the second fixing device 620 through the second connection path P2 and reaches the feeder rollers 62c arranged in the second fixing device 620. By rotation of the feeder rollers 62c, the printing medium S is supplied between the second heating roller 62a and the second pressure roller 61b of the second fixing device 620. A feeding guide member 62d may be disposed between the feeder rollers 62c and the second heating and pressure rollers 62a and 62b, to guide the front end of the printing medium S between the second heating roller 62a and the second pressure roller 62b.

Referring to FIG. 3E, the printing medium S may be supplied from the separate space 800 to the second fixing device 620, and secondary fixing may be performed on the printing medium S. In this case, the rotation speed of the feeder rollers 62c corresponds to the second moving speed of the second fixing device 620, and therefore, the printing medium S is supplied to and moved in the second fixing device 620 at the second moving speed.

In the example described above, the fixing condition of the first fixing device 610 may be set to a condition appropriate for normal printing, and the fixing condition of the second fixing device 620 may be set to a condition appropriate for photofinishing printing.

By setting the second moving speed of the second fixing device 620 to be lower than the first moving speed of the first fixing device 610, fixing quality of a clear toner used for photofinishing may be improved. In addition, by cooling the fixing surface of the printing medium S by the cooling device 650 (for example, by contacting external air through a duct) while the printing medium S moves from the second fixing device 620 to the second outlet E2, the fixing quality of the clear toner may be further improved.

Referring to the movement path of the printing medium S shown in FIG. 3A to FIG. 3E, it may be understood that the first fixing device 610 and the second fixing device 620 may fix the same surface of the printing medium S.

The printing medium S that has been secondarily fixed at the second fixing device 620 passes through the cooling device 650 and is discharged through the second discharge rollers 725.

In various examples, not all printing media S are required to be fixed along a path passing through both the first fixing device 610 and the second fixing device 620. That is, when the fixing of the printing medium S is performed only for normal printing (for example, printing on a plain paper not requiring photofinishing), the printing medium may be completely discharged through the first outlet E1 after the fixing by the first fixing device 610.

Referring to FIG. 3E, while the printing medium S undergoes the secondary fixing while passing through the second fixing device 620, the first fixing device 610 may initiate a primary fixing for a new printing medium S′. While the secondary fixing of the printing medium S proceeds, the new printing medium S′ may be finished with a primary fixing, which is faster than the secondary fixing, and enter the separate space 800 for the secondary fixing. Therefore, the second fixing device 620 may continuously fix the consecutive printing media S and S′, and an overall speed of the image forming apparatus 1 for photofinishing printing may be improved.

The time point for initiating the primary fixing of the new printing medium S′ may be set to a time point that enables the new printing medium S′ to enter the separate space 800 after the printing medium S exits the separate space 800, such that an interference between the two printing media S and S′ may be avoided.

In an example, the image forming apparatus 1 may be capable of duplex printing, and the first connection path P1 may also be used as a path for duplex printing.

Referring to FIG. 3F, for duplex printing, the image forming apparatus 1 moves the printing medium S backward from the first discharge device 710 to the separate space 800. At this time, unlike secondary fixing using the second fixing device 620, for duplex printing, the printing medium S is moved further backward, and is supplied again to the transfer device 50 and the first fixing device 610, where an image may be formed on a back surface of the printing medium S. This duplex printing path Pb shares the first connection path P1 for secondary fixing, as shown in FIG. 3F. That is, the printing medium S may be moved to the second fixing apparatus 620 by using a connection path for duplex printing. Thus, the image forming apparatus 1 may have both a duplex printing function and an additional fixing function for photofinishing printing.

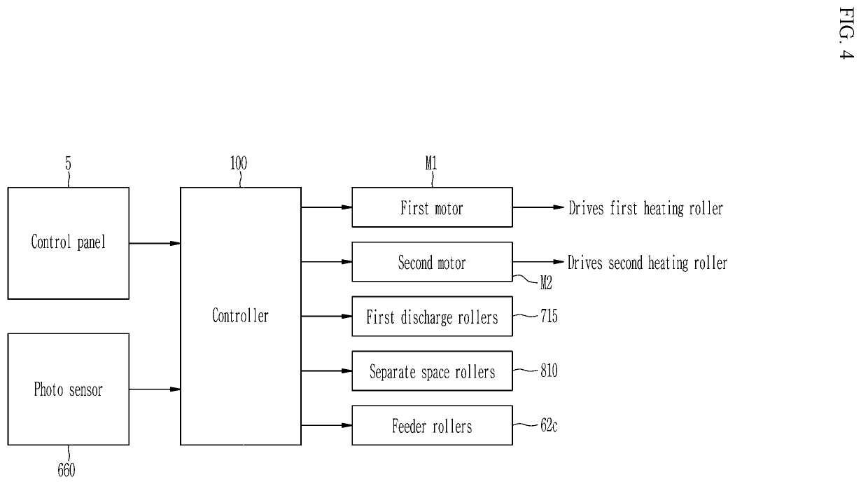

FIG. 4 is a block diagram showing a control configuration of an image forming apparatus according to an example.

Referring to FIG. 4, the photo sensor 660 may detect that the rear end of the printing medium S leaves the gate flap FL of the first fixing device 610. The main body 10 may be provided with a control panel 5 (e.g. a user interface) for a user to operate the image forming apparatus 1, and the user may input, through the control panel 5, whether normal printing or photofinishing printing is to be performed. In an example, instead of a user's input, a printing medium sensor (not shown) for detecting whether the printing medium S is a plain paper or a photofinishing paper may be provided, and whether normal printing or photofinishing printing is to be performed may be determined based on the detection result of the sensor.

A controller 100 controls movement and fixing of the printing medium S transferred with an image based on a determined print quality (e.g., normal printing or photofinishing printing), while monitoring a sensed value of the photo sensor 660.

The first fixing device 610, for example, the first heating roller 61a, is driven by the first motor M1, and the second fixing device 620, for example, the second heating roller 62a, is driven by the second motor M2. The first motor M1 and the second motor M2 are operated under the control of the controller 100.

In addition, the controller 100 controls movement of the printing medium S by controlling the pair of first discharge rollers 715, the separate space rollers 810, and the feeder rollers 62c.

It has been described above that the second moving speed of the second fixing device 620 may be lower than the first moving speed of the first fixing device 610 and thereby the fixing quality of the clear toner at the second fixing device 620 may be improved. In this case, a maximum available rotation speed of the second motor M2 for implementing the second moving speed may be lower than a maximum available rotation speed of the first motor M1 for implementing the first moving speed. A high-speed motor may show less controllability at a low speed, and a low speed control may be more precise as a maximum rotation speed of a motor is lower. Therefore, by using a low speed motor, that is, a motor having a low maximum rotation speed, as the second motor M2 as compared with the first motor M1, the precision of fixing for photofinishing printing may be improved.

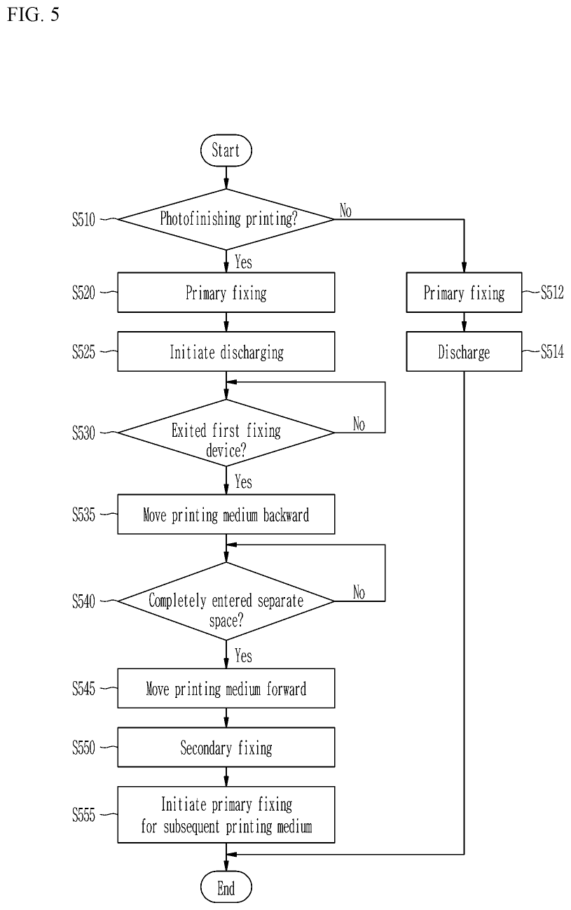

FIG. 5 is a flowchart of an image forming method according to an example.

Referring to FIG. 5, the controller 100 may determine whether ongoing printing of the printing medium S is normal printing or photofinishing printing at operation S510. The determination may be, for example, an input by a user through the control panel 5 or may be a detection result of whether the printing medium S is plain paper or photographic paper.

In the case of normal printing, the controller 100 fixes, in the first fixing device 610, the printing medium S transferred with an image by the transfer device 50 at operation S512 and discharges the printing medium S through the first outlet E1 by the first discharge device 710 at operation S514.

In the case of photofinishing printing, the controller 100 fixes, in the first fixing device 610, the printing medium S transferred with an image by the transfer device 50 at operation S520 and starts to discharge the printing medium S through the first outlet E1 by driving the first discharge device 710 at operation S525.

At operation S520, while the first fixing device 610 fixes the printing medium S, the controller 100 moves the printing medium S at the first moving speed. The first moving speed may be set to a speed appropriate for normal printing (e.g., 30 ppm).

While the printing medium S is being discharged by the first discharge device 710, the controller 100 determines whether the rear end of the printing medium S has exited the first fixing device 610 at operation S530. Whether the rear end of the printing medium S has exited the first fixing device 610 may be determined, for example, based on whether the printing medium S is detected by a detector (e.g., photo sensor 660) disposed between the first fixing device 610 and the first discharge device 710.

When the rear end of the printing medium S has exited the first fixing device 610, the controller 100 drives the first discharge device 710 in the reverse rotation at operation S535. By the reverse rotation of the first discharge device 710, the printing medium S enters the separate space 800 from the first discharge device 710.

At operation S535, in addition to driving the first discharge device 710 in the reverse rotation, the controller 100 may also drive the separate space rollers 810 of the separate space 800 in the reverse rotation. Therefore, even when the printing medium S leaves the first discharge device 710 while moving backward, the printing medium S may enter the separate space 800 by the reverse rotation of the separate space rollers 810.

The controller 100 determines whether the printing medium S has completely entered the separate space 800 at operation S540. Whether the printing medium S has completely entered the separate space 800 may be determined, for example, by calculating a backward movement distance of the printing medium S due to reverse rotation of the first discharge device 710 and the reverse rotation of the separate space rollers 810.

In various examples, the backward moving speed of the printing medium S by the reverse rotation of the first discharge device 710 and the separate space rollers 810 is not be limited to a specific speed. The backward moving speed of the printing medium S entering the separate space 800 may be an arbitrary speed at which the printing medium S in the image forming apparatus 1 may stably enter the separate space 800 from the first discharge device 710.

When the printing medium S has completely entered the separate space 800, the controller 100 may move the printing medium S from the separate space 800 to the second fixing device 620 by driving the separate space rollers 810 in the forward rotation at operation S545. At operation S545, the controller 100 may supply the printing medium S into the second fixing device 620 by driving the feeder rollers 62c of the second fixing device 620 in the forward rotation.

The controller 100 performs additional fixing of the printing medium S by the second fixing device 620 at operation S550. That is, for the additional fixing, the printing medium S may be disposed in a different space (i.e., the space where the second fixing device 620 is disposed) from a space in which the primary fixing occurs (i.e., the space where the first fixing device 610 is disposed), and the additional fixing may be performed at the different space.

In an example, the controller 100 may drive the feeder rollers 62c and the second motor M2 for the second fixing device 620 such that the printing medium S may pass through the second fixing device 620 at the second moving speed. The second moving speed may be a moving speed appropriate for photofinishing printing, and may be a speed (e.g., 4 ppm) lower than the first moving speed.

During a process for supplying the printing medium S from the first fixing device 610 to the second fixing device 620 that have different moving speeds, the printing medium S is moved in reverse direction once at operation S535, and thereby an undesirable bending of the printing medium according to a speed difference between the two fixing devices 610 and 620 may be prevented.

On the other hand, while the current printing medium S undergoes the secondary (i.e., additional) fixing at the second fixing device 620, the controller 100 may initiate primary fixing of a subsequent printing medium S′ by driving the first fixing device 610 for the subsequent printing medium S′ at operation S555. That is, the secondary fixing for the current printing medium S and the primary fixing for the subsequent printing medium S′ may be simultaneously performed at least partially. Therefore, immediately after the current printing medium S leaves the separate space 800 and the separate space 800 is emptied, the subsequent printing medium S′ may be finished with the primary fixing and may enter the separate space 800 to wait for the secondary fixing. Therefore, after finishing secondary fixing of the current printing medium S, the second fixing device 620 having a lower moving speed may immediately initiate secondary fixing of a subsequent printing medium S′ without any waiting time for a supply of the subsequent printing medium S′. Therefore, an overall photofinishing printing speed of the image forming apparatus 1 may be improved.

The example methods as described above may be implemented as a computer program including at least one sequence of computer-readable instructions describing the disclosed example methods. In addition, parts of disclosed apparatus may be implemented in the form of a data storage medium or at least one processor where the computer program is stored or executed.

It will be understood that the described examples may be practiced in a modified way other than as described. Therefore, such modifications are intended to be within the meaning and range of equivalents of the disclosed examples, based on the teaching and guidance presented herein. It is to be understood that the phraseology or terminology herein is for the purpose of description by example, and not of limitation, such that the terminology or phraseology of the present specification is to be interpreted by the skilled artisan in light of the teachings and guidance.

What is claimed is:

1. An image forming apparatus comprising:
a main body;
a first fixing device disposed in the main body to primarily fix a toner image transferred on a printing medium while passing through a transfer device;
a first discharge device to discharge the printing medium having passed through the first fixing device from the main body; and
a second fixing device disposed in the main body to additionally fix the toner image on the printing medium having passed through the first fixing device,
wherein the second fixing device is supplied with the printing medium through a connection path forming a connection from the first fixing device to the second fixing device.

2. The image forming apparatus of claim 1, wherein the connection path comprises:
a first connecting path through which the printing medium is to move backward from the first discharge device into the main body; and
a second connection path through which the printing medium is to move forward to the second fixing device in a direction opposite to the first connection path.

3. The image forming apparatus of claim 2, wherein:
the first connection path is to provide a path for duplex printing of the printing medium.

4. The image forming apparatus of claim 2,
wherein a separate space for reversing a moving direction of the printing medium is disposed between the first connection path and the second connection path, and
wherein the separate space is disposed between the main body and a lateral side of the first fixing device.

5. The image forming apparatus of claim 4, wherein the second fixing device is disposed above the separate space.

6. The image forming apparatus of claim 1, wherein, while the second fixing device additionally fixes a current printing medium, the first fixing device is to primarily fix a subsequent printing medium.

7. The image forming apparatus of claim 1, wherein the second fixing device includes a fixing device for photofinishing.

8. The image forming apparatus of claim 1,
wherein the first fixing device is to primarily fix the printing medium while moving the printing medium at a first moving speed, and
wherein the second fixing device is to additionally fix the toner image on the printing medium while moving the printing medium at a second moving speed lower than the first moving speed.

9. The image forming apparatus of claim 8,
wherein the first fixing device is to move the printing medium by a first motor,
wherein the second fixing device is to move the printing medium by a second motor, and
wherein the second motor has a lower maximum rotation speed than the first motor.

10. The image forming apparatus of claim 1, further comprising a second discharge device to discharge the printing medium having passed through the second fixing device,
wherein, in normal printing, the printing medium is discharged from the first fixing device through the first discharge device, and
wherein, in photofinishing printing, the printing medium is discharged through the second discharge device after sequentially passing through the first fixing device and the second fixing device.

11. The image forming apparatus of claim 10, wherein an outlet of the first discharge device and an outlet of the second discharge device are disposed to face a same direction.

12. An image forming method, comprising:
transferring an image to a printing medium;
primarily fixing a transfer surface of the printing medium to which the image is transferred;
disposing the printing medium in a different space from a space in which the primary fixing occurs by moving the printing medium backward from the space in which the primary fixing occurs and then moving the printing medium forward to the different space; and
secondarily fixing the transfer surface of the printing medium in the different space.

13. The image forming method of claim 12,
wherein the primary fixing is performed while moving the printing medium at a first moving speed, and
wherein the secondary fixing is performed while moving the printing medium at a second moving speed lower than the first moving speed.

14. The image forming method of claim 12, further comprising determining whether ongoing image forming is normal printing or photofinishing printing,
wherein the secondary fixing is performed in the case of photofinishing printing.

15. The image forming method of claim 12, wherein, while the secondary fixing is performed for a current printing medium, the primary fixing is initiated for a subsequent printing medium.
